(19) United States
(12) Patent Application Publication
(10) Pub. No.: US 2007/0237611 A1
(43) Pub. Date: Oct. 11, 2007

(54) Rack with forklift pocket

(76) Inventor: Merle A. Grams, Sylvania, OH (US)

Correspondence Address: MARSHALL & MELHORN, FOUR SEAGATE, EIGHT FLOOR, TOLEDO, OH, 43604, US

(21) Appl. No.: 11/784,629

(22) Filed: Apr. 9, 2007

Related U.S. Application Data
(60) Provisional application No. 60/790,922, filed on Apr. 11, 2006.

(51) Int. Cl. B65G 1/00

(52) U.S. Cl. 414/331.01

(57) ABSTRACT

A forklift pocket for a rack or container has a top surface defined by a material having a plurality of apertures therein. The pocket defines a hollow interior portion with which the apertures are in fluid communication.

### RELATED APPLICATION

This application is claiming the benefit, under 35 U.S.C. § 119(e), of the provisional application filed Apr. 11, 2006 under 35 U.S.C. § 111(b), which was granted Ser. No. 60/790,922. This provisional application is hereby incorporated by reference.

### FIELD OF THE INVENTION

The present invention relates to a rack or container having at least one forklift pocket for receiving the tines of a forklift type vehicle.

### BACKGROUND OF THE INVENTION

Pockets for receiving the tines of a forklift type vehicle in containers or racks are well-known to those skilled in the art. The vehicle may be a forklift, or an auto guided vehicle, or any other vehicle having similar tine structures. The term forklift will be used herein to refer to all vehicles having such tine structures used for moving containers or racks.

The pockets have at least one open end and a substantially hollow interior for receiving the forks, or tines, of a forklift so that the container or rack can be moved by the forklift. Usually, the pockets are substantially rectangular in shape. The pockets typically are attached by welding at least at one of their ends to the rack or frame and welding their other end to the rack or frame. Typically, the forklift pockets are fabricated from solid sheets of metal.

A forklift pocket that has solid upper, lower and side surfaces uses a substantial amount of metal. Use of metal in this amount adds a substantial amount of weight to the rack or carrier. Furthermore, constructing the fork pockets out of solid sheets of metal adds to the cost of the rack or container.

The fork pockets of the prior art racks or containers suffer from other disadvantages. For example, the racks/containers are frequently exposed to many kinds of indoor and outdoor environmental conditions. For example, the racks or containers are frequently exposed to rain, snow and sleet when they are stored or transported outdoors. Fork pockets that are constructed of solid sheets of metal can hold water and ice on their upper surfaces making them slippery and dangerous. These prior art designs are also prone to rust since water can be trapped for long periods of time in or on the fork pockets.

### BRIEF DESCRIPTION OF THE DRAWINGS

FIG. 1 is a schematic, perspective view of a preferred embodiment of the present invention;

FIG. 2A is a schematic, perspective view of one embodiment of a component that is depicted in FIG. 1;

FIG. 2B is a schematic, perspective view of another embodiment of a component that is depicted in FIG. 1;

FIG. 3A is a schematic, perspective view of another embodiment of the present invention;

FIG. 3B is a schematic, perspective view of a portion of the bottom of the invention depicted in FIG. 3A; and

FIG. 4 is a schematic, perspective view of another embodiment of the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the present invention. Hence, specific dimensions, directions or other physical characteristics relating to the embodiments disclosed are not to be considered as limiting, unless expressly stated otherwise.

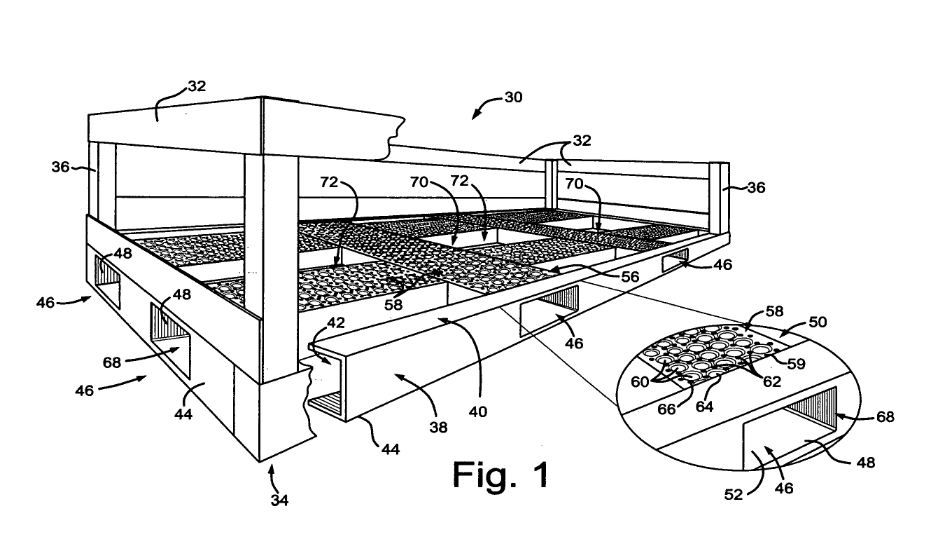

Turning now to FIG. 1, a preferred embodiment of the present invention is depicted. The present invention is a movable rack 30, or container, which may comprise a top framework 32, a base framework 34 and four uprights 36 connecting the top framework 32 and base framework 34. A portion of the top framework 32 has been broken away so that other features of the rack 30 can be seen. While FIG. 1 depicts a substantially rectangular rack 30, it should be appreciated that the present invention works equally well with racks of any shape or size with any number of uprights 36 and any top framework 32, or no top framework 32 or uprights 36 at all.

The base framework 34 is comprised of four beams in the preferred embodiment. Each beam preferably comprises an outer perimeter surface 38, an upper surface 40 and a bottom surface 44. The outer perimeter surface 38, the upper surface 40 and the bottom surface 44 of each beam are preferably substantially planar. The surfaces 38, 40 and 44 are arranged to create a C-shape 42. The C-shape 42 accommodates the fork pocket described below. Other base framework 34 structures comprised of greater or fewer beams, or surfaces, are within the scope of the present invention. For example, one or more beams may have an upper surface, a bottom surface and two side surfaces.

The uprights 36 connect the base framework 34 to the top framework 32. The uprights 36, as well as the base framework 34, and the top framework 32, are typically fabricated from sheets or tubes of metal. It can be appreciated that the uprights 36 can be two-sided or four-sided.

Additionally, while an open sided, open top rack 30 is depicted in FIG. 1, it can be appreciated that the present invention works equally well with racks or containers that are fully enclosed, or partially enclosed, such as with sides or a top

The rack 30 depicted in FIG. 1 may be used in a variety of different ways. By way of just one example, which the present invention is not limited to, the rack 30 may be used to transport parts, such as vehicle parts (now shown). Typically, the vehicle parts are placed on or in the rack 30; structures such as pads (not shown), may be used to separate the parts and keep them from contacting one another and from contacting the rack 30.

FIG. 1 depicts four fork pockets 46 extending across the base framework 34 of the rack 30 at preferred locations. It should be appreciated, however, that any number of fork pockets 46 may be installed on the rack 30 and that they may be located anywhere on the base framework 34 or elsewhere on the rack 30. The fork pockets 46 preferably extend from one side of the base framework 34 to the other side of the base framework 34 and they are secured to the base framework 34 by welding and/or mechanical fasteners. In a more preferred embodiment, the ends of each fork pocket 46 extend into the C-shapes 42 of the framework. The C-shapes 42 provide support to the pockets 46 and they provide an attachment surface so the pockets 46 can be welded and/or attached to the framework by mechanical fasteners. If something other than a C-shape is utilized, the pockets 42 are nevertheless preferably attached to the framework.

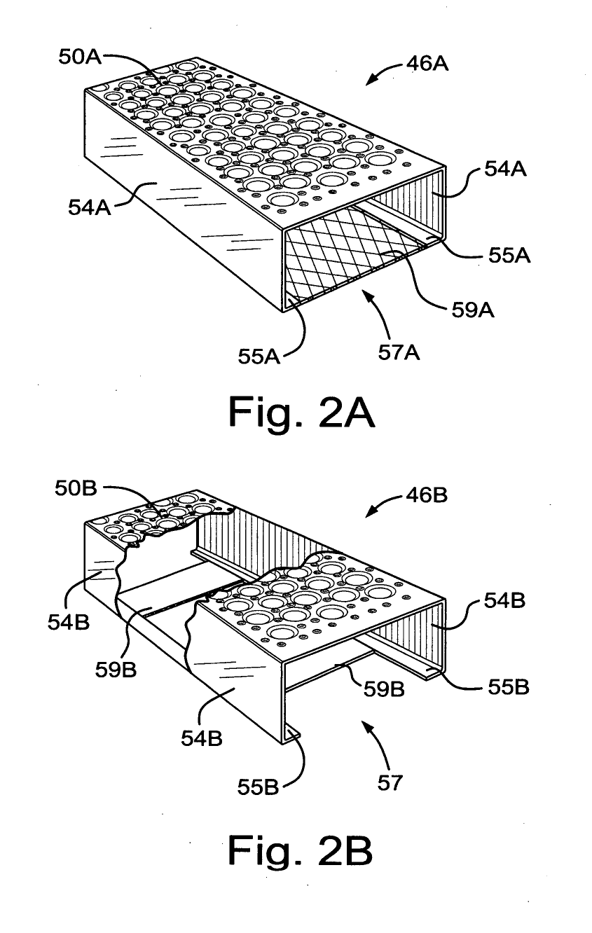

As best seen in FIGS. 2A and 2B, each fork pocket 46 preferably comprises a top surface 50 and two side surfaces 54. It is within the scope of the present invention, however, to vary the number of members that comprise the fork pocket 46 as well as their orientation with respect to one another.

For example, the fork pocket 46 may or may not have a full, or even a partial, bottom surface 52 on one or more pockets 46. If a bottom surface 52 does exist, it may be integrally formed with the pocket 46 or formed separately therefrom and attached by welding and/or mechanical fasteners.

For example, referring to FIG. 2A, one embodiment of a forklift pocket 46A is depicted. Forklift pocket 46A has similar features to pocket 46 so similar features are identified with similar reference numbers having the letter A attached.

The pocket 46A has a top surface 50A, and two side surfaces 54A. The side surfaces 54A have lower flanges 55A that extend inwardly from and perpendicular to, the side surfaces 54A. Preferably, the flanges 55A are separated by a gap 57A. A grate-type material 59A is secured, either by welding and/or mechanical fasteners, to the flanges 55A. The grate-type material 59A permits air, heat and light to enter and leave the pocket 46A.

Looking now at FIG. 2B, another embodiment of a forklift pocket 46B is depicted. Forklift pocket 46B has similar features to pocket 46A so similar features are identified with similar reference numbers having the letter B attached to them.

Pocket 46B has all the attributes of the pocket 46A described above and depicted in FIG. 2A except that the plates 59B are selectively used to define the bottom surface 52B. It is within the scope of the present invention to fully enclose the bottom surface 52B with one or more plates 59B.

Regardless of the bottom surface utilized, if one is used at all, at least the top surface 50 and the side surfaces 54 comprise a one-piece modular structure that can be located in the rack 30.

Looking now at FIG. 1, the base framework 34 defines entranceways 48 for the fork pockets 46 in the outer perimeter surface 38 of the framework 34. The entranceways 48 are substantially planar with the outer perimeter surface 38.

In the preferred embodiment, each top surface 50 of each fork pocket 46 is preferably constructed of a material 56 having a plurality of apertures 58. It can be appreciated that the apertures 58 permit air, heat and light into the fork pockets 46. The apertures 58 reduce the amount of material required for the top surface 50, thus reducing the weight of the fork pocket 46. The apertures 58 are separated from one another by planar areas 59.

In the depicted embodiments of the invention, the plurality of apertures 58 comprises a first plurality of apertures 60 and a second plurality of apertures 62. Preferably, the apertures of the first plurality of apertures 60 are intermingled with the apertures of the second plurality of apertures 62. It is also preferred that the apertures of both pluralities 60, 62 extend substantially across the top surface 50 of each fork pocket 46. A preferred embodiment of the invention also comprises both pluralities of apertures 60, 62 extending through the material 56.

The first plurality of apertures 60 comprise debossed holes of approximately 0.25 inches to approximately 3 inches in diameter. For purposes of this application, a debossed hole is defined by a rim 64 that extends substantially into the fork pocket 46. The second plurality of apertures 62 comprises holes that are smaller, typically on the order of approximately 0.05 to approximately 0.2 inches in diameter.

The above-mentioned dimensions of the first and second plurality of apertures 60, 62 are in no way limiting to the present invention and apertures that are larger or smaller are within the scope of the present invention. It is also within the scope of the present invention for the apertures to be any shape including circular, oval, square, rectangular, diamond shaped or polygonal.

Preferably, each aperture in the second plurality of apertures 62 is defined by a rim 66 that extends outwardly from the top surface 50 of the fork pocket 46. As mentioned above, it is preferred that the rim 64 around each aperture of the first plurality of apertures 60 extends inwardly. It should be appreciated, however, that the rims 66 of the second plurality of apertures 62 can extend inwardly and the perimeters of the first plurality of apertures 60 can extend outwardly. Furthermore, the perimeter around each aperture of both pluralities of apertures 60, 62 can extend outwardly.

It is also within the scope of the present invention for the fork pockets 36 to have only a single plurality of apertures, such as just one of the plurality of apertures, 46 or 48, described above, or the fork pockets 36 may also have multiple pluralities of various apertures.

The rims 66 of the apertures 62 increase slip resistance for anyone working on or in the rack 30. Because the rims 66 preferably extend substantially vertically from the top surface 50 of the fork pocket 46, slip resistance is provided in all directions.

Both of the apertures 60, 62 function to frustrate ice formation on the top surface 50 of the fork pocket 46 since their rims 64, 66 create a variable surface on which ice cannot adequately secure itself.

The top surface 50 and side surfaces 54 (and the bottom surfaces 52, if present) of each fork pocket 46 form a substantially hollow interior portion 68. The substantially hollow interior portion 68 is large enough to receive a fork, or tine, from a forklift.

In the preferred embodiment depicted in FIG. 1, the fork pockets 46 extend from one side of the base framework 34 to a parallel side of the base framework 34. When there are four fork pockets as shown in FIG. 1, the fork pockets 46 that extend from sides of the base framework 34 that are perpendicular to one another preferably intersect with one another, such at intersection point 70.

The fork pockets 46 may be constructed of any resilient material. By way of example, the fork pockets 46 may be constructed of metal, such as stainless steel, to resist rust. Other materials, such as aluminum alloys, or polymers, such as plastic, may be used to save weight. Materials may also be utilized that are corrosion-resistant or which may be coated or painted to resist deterioration.

The top surface 50 may be integrally formed and one-piece with the side surfaces 54 and the bottom surface 52. Alternatively, the top surface 50 may be separately formed and secured to the side surfaces 54 by welding and/or mechanical fasteners. Regardless, it is preferred that the top surface 50 is located in the rack 30 so that it is substantially planar with the upper surface 40 of the base framework 34.

It is also preferred that the base framework 34 and the fork pockets 46 define among them a plurality of non-vertically bounded voids 72. These voids 72 are horizontally bound by the base framework 34 and the fork pockets 46, but there is substantially no structure in the rack 30 that bounds them in the vertical direction. Thus, fluids, such as liquids and air, and heat and light are free to pass through the voids 72 uninterrupted and without being captured. The voids 72 also make the rack lighter.

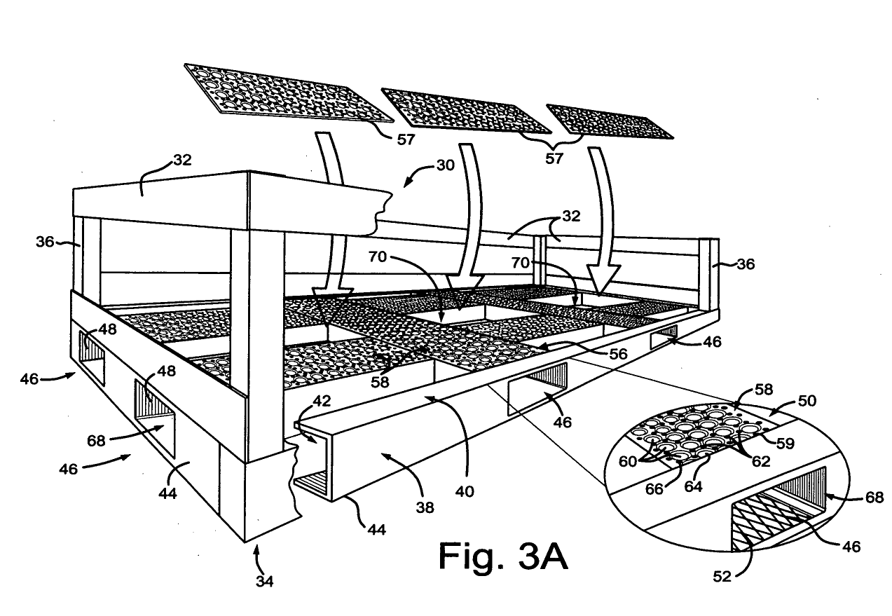

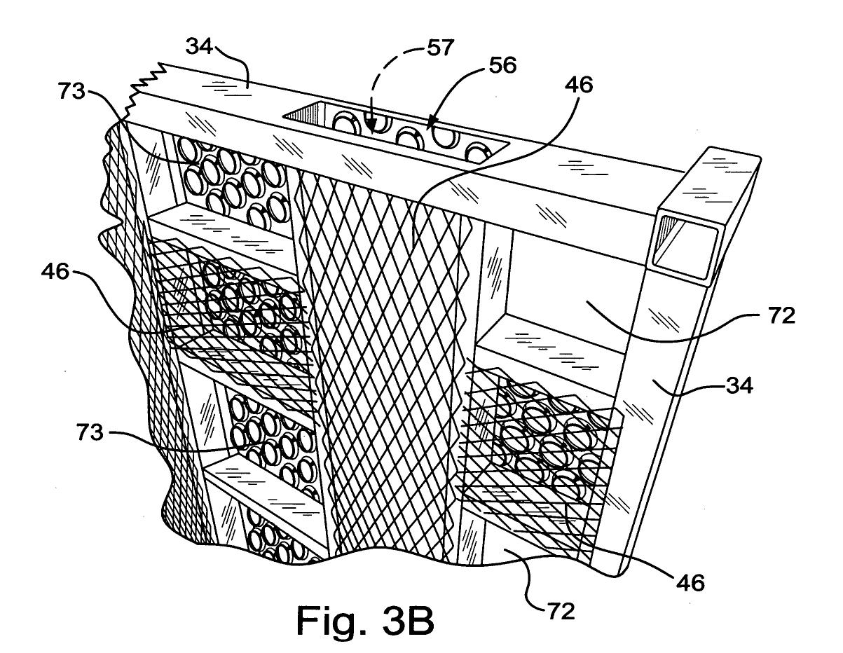

In some cases, it may be desirable to use the same material 56 that forms the top surface 50 of the fork pockets 46 between the fork pockets 46. FIGS. 3A and 3B depict the embodiment where a portion of the material 56 is located between the fork pockets 46 so as to provide a larger work or walk surface 57 on the rack 30. Preferably, the walk surface 57 is substantially planar with the top surface 50 of the fork pocket 46. The material 56, the fork pockets 46 and the base framework 34 thus form 5 sided cells 73 within the rack 30. The bottom of the cell 73, comprising the sixth side of the cell 73, is left open. Individual sheets of material 56 can also be located anywhere between the fork pockets 46 and the framework 34.

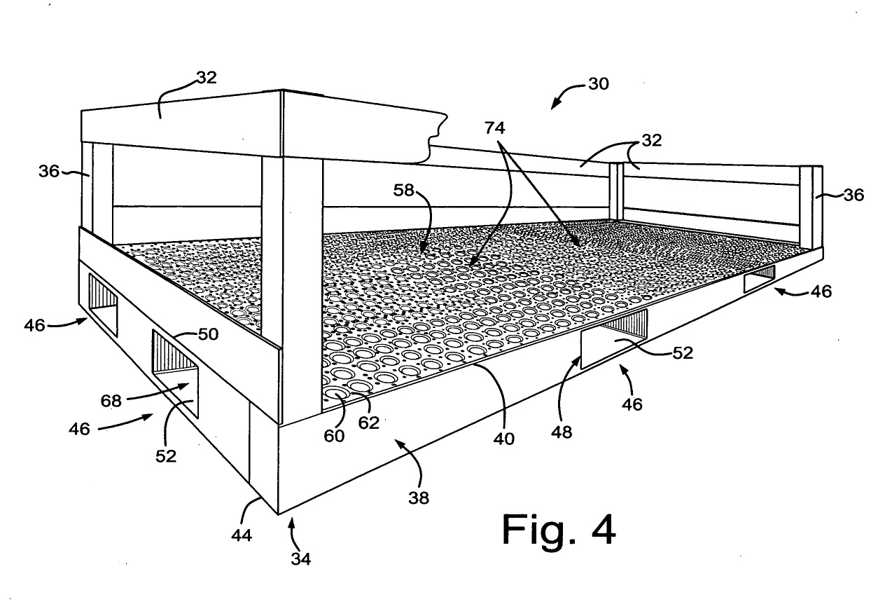

Turning now to FIG. 4, an additional embodiment of the present invention is depicted. Identical reference numbers will be used for like features in FIG. 4 as utilized in the preceding figures and description.

A substantially continuous sheet of material 74, preferably having both the first plurality of apertures 60 and the second plurality of apertures 62, is located over the base framework 34. Preferably, the sheet of material 74 extends from one side of the rack 30 to the other side of the rack 30 and from front to back. The sheet of material 74 thus provides a substantially continuous surface from one side to the other side of the base framework 34. This design provides a substantially continuous surface to walk or work on. The sheet of material 74 may be attached to the upper surface 40 of the base framework 34, such as with mechanical fasteners and/or welding, or the sheet of material 74 may simply rest on the upper surface 40. It can be appreciated that the sheet of material 74 can form the top surface 50 of the fork pockets 46.

Those skilled in the art will appreciate that the base framework 34 can also be substantially covered by pieces of the material 56 that are welded into place as opposed to using the single sheet 74.

In accordance with the provisions of the patent statutes, the present invention has been described in what is considered to represent its preferred embodiments. However, it should be noted that the invention can be practiced otherwise than as specifically illustrated and described without departing from its spirit or scope.

I claim:

1. A movable rack for transporting one or more parts, comprising:
a base framework for a movable rack, said base framework comprising four sides, each of said sides having an outer perimeter surface and an upper surface; and
at least two forklift pockets substantially extending from one of said four sides to another of said four sides, said base framework defining at least two separate entranceways into said at least two forklift pockets in said outer perimeter surface, said forklift pockets each having substantially solid side surfaces, wherein a top portion of each of said forklift pockets is formed by at least one sheet of material having a plurality of apertures extending therethrough, said at least one sheet of material being substantially planar with said upper surface of said base framework;
wherein said forklift pockets and said base framework define a plurality of non-vertically bounded voids within said rack.

2. The movable rack of claim 1, wherein said outer perimeter surface is substantially planar and uninterrupted except for said fork pocket entranceways.

3. The movable rack of claim 1, wherein a first forklift pocket and a second forklift pocket both extend from a first side to a second side of said base framework and a third forklift pocket and a fourth forklift pocket both extend from a third side to a fourth side of said base framework, wherein at least one of said first forklift pocket or said second forklift pocket intersects with said third and said fourth forklift pockets.

4. The movable rack of claim 1, wherein said plurality of apertures is defined by a first plurality of apertures and a second plurality of apertures, wherein said first plurality of apertures are debossed holes and said second plurality of apertures, which are intermingled among said first plurality of apertures, have a rim that extends outwardly from an upper surface of said sheet of material.

5. A forklift pocket for a movable rack, said pocket comprising four sides that are comprised of two solid side surfaces, at least a partial bottom surface and a top surface, said four sides defining a substantially hollow interior portion, wherein said top surface is comprised of a plurality of apertures that extend substantially entirely across said top surface and that extend through to said hollow interior portion.

6. The forklift pocket of claim 5, wherein said plurality of apertures are defined by a first plurality of apertures and a second plurality of apertures, wherein said first plurality of apertures are debossed holes and said second plurality of apertures, which are intermingled among said first plurality of apertures, have a rim that extends outwardly from said top surface.

7. The forklift pocket of claim 5, wherein said pocket is located within a base framework of said rack, said pocket supporting a sheet of material containing said plurality of apertures.

8. The forklift pocket of claim 7, wherein said sheet of material extends substantially to each of said four sides of said rack.

9. The forklift pocket of claim 7, wherein said sheet of material only extends over said forklift pocket.

10. The movable rack of claim 7, wherein said four members of said base framework and said forklift pockets define a plurality of non-vertically bound voids between them.

11. A movable rack, comprising:
at least two pockets located within a framework for accepting the tines of a vehicle, said pockets each having an upper surface and two side surfaces;
a plurality of apertures on said upper surface of said pockets, said apertures having upstanding rims separated by planar areas; and
a walk surface between said pockets, said walk surface having a plurality of apertures with upstanding rims separated by planar areas, said walk surface being substantially planar with said upper surface of said pockets;
wherein said framework, said pockets and said walk surface forms at least one 5 sided cell in a rack for transporting parts.

12. The rack of claim 11, wherein said plurality of apertures on said upper surface of said pockets and said plurality of apertures on said walk surface permit fluids to pass into and out of said rack.

13. The rack of claim 11, wherein a bottom surface of each of said fork pockets is defined by a sheet of grate material.

14. The rack of claim 11, wherein members of said framework have inwardly facing C-shaped channels for accepting said forklift pockets.

15. The rack of claim 11, wherein each of said pockets comprise a one-piece module that is installed in said rack.
